(19) United States
(12) Patent Application Publication
(10) Pub. No.: US 2015/0369110 A1
(43) Pub. Date: Dec. 24, 2015

(54) Serviceable Soft Gaskets for Durable Heat Shielding

(71) Applicant: Caterpillar Inc., Peoria, IL (US)

(72) Inventors: Ryan McHenry, Crawfordsville, IN (US); Jeremy Byrd, West Lafayette, IN (US)

(21) Appl. No.: 14/311,753

(22) Filed: Jun. 23, 2014

(51) Int. Cl. F01N 13/10; F02B 39/00; F16J 15/02; F01N 13/14

(52) U.S. Cl. CPC F01N 13/102; F01N 13/14; F02B 39/00; F16J 15/028; F16J 15/022

(57) ABSTRACT

An engine with a heat shielding enclosure system is disclosed. The heat shielding enclosure system uses serviceable, malleable gaskets to provide an improved seal to reduce the amount of heat escaping from the heat shielding enclosure and to allow for the gaskets to be serviced at low cost and difficulty.

### TECHNICAL FIELD

The present disclosure relates generally to sealing gaskets for heat shielding of an engine. More specifically, this disclosure relates to sealing gaskets for components interfacing with a heat shielding enclosure.

### BACKGROUND

Internal combustion engines produce hot air exhaust during normal operation as a result of the combustion process. This hot air exhaust may be directed away from cylinders through exhaust systems, including exhaust manifold assemblies of various configurations. Engine components coming in contact with exhaust gases may increase in temperature significantly, particularly when the engine is at full load. The skin temperature of engine components may pose a risk to engine operators and may reduce engine efficiency and damage components. Heat shielding may be used to guard against these risks.

One approach to heat shielding is a heat shielding enclosure. A heat shielding enclosure, or “box,” is a type of heat sink that may be mounted onto an engine to directly cover components operating at a high skin temperature and to reduce the amount of heat introduced to the engine's operating environment. Heat shielding enclosures may be formed using skins of metal and thermal insulating material. A heat shielding enclosure does not require an engine to be designed with the enclosure in mind; heat shielding enclosures may be applied as a retrofit. The enclosures may be constructed to interface with engines of different sizes and with different components and different configurations of components.

Heat shielding enclosures may be connected with, for example, an engine's exhaust manifold, turbochargers, and exhaust outlet elbow. Sensors, such as thermocouples, may also connect with the enclosure. For example, an engine may use thermocouples to measure the temperature of gas upstream and downstream from a turbocharger. Heat shielding enclosures have seals of rigid, non-elastomeric, non-resilient material which meet at the interfaces of these components with the heat shielding enclosure. These mating points are challenging to seal, and the structure required at the interface due to the shape of the components at that point can create challenges to forming an effective seal. Heat and vibration generated by engine operation may create or expand gaps between engine components and the heat shielding enclosure. The ability to service seals is limited and costly.

Permanent seals for heat shielding enclosures cannot be individually serviced. In order to replace worn, faulty, or damaged seals, entire sections of insulation may need to be replaced, or possibly even the entire heat shielding enclosure. Furthermore, components connected with the enclosure typically require servicing. For example, turbochargers are partially inside the heat shielding enclosure, requiring the heat shielding enclosure to be accessed to service the turbochargers. Additionally, regular inspections, either required by regulations, protocol, or for performance, may require the heat shielding enclosure to be accessed. The more the heat shielding enclosure is accessed, the more wear is introduced, particularly to the permanent seals. As the seals weaken, gaps are introduced and widened between the heat shield and components, such as the exhaust outlet elbow. More interaction by operators and service personnel increases the risk of damage to seals by human error. The increased wear raises the risk of thermal leakage.

In addition to being a safety hazard, heat and gas leaks are regulated and failure to meet the regulations may result in fines and other penalties. For instance, for engines in marine environments, the International Marine Organization (IMO) has a regulatory framework under the Safety of Life at Sea (SOLAS) Convention addressing engine fuel leaks and engine skin temperature. A hot engine surface coming into contact with a fuel or oil leak can result in a fire. Leaks may not necessarily be a single component failure, such as a pipe under pressure failing and spraying fuel. Gaps between engine components may allow fuel gas or blended exhaust-fuel gas to leak from the engine. Leaking gas may reduce engine efficiency, cause environmental damage, and be a healthy and safety hazard to engine operators. Radiant heat from engine components may also cause gas dispersed in the ambient air to reach flashpoint. Heat shielding enclosure seals need to be as tight as possible to help prevent leaked gas from coming into contact with high temperature engine components, such as turbocharger turbine housings.

Turbochargers extract energy coming from the exhaust manifold. The intake air may be blended with fuel, such as natural gas, biogas, propane, and mixed gases, for example, before it enters the turbocharger compressor section. A throttle valve may be utilized to control the blending of fuel and intake air. Sealing the interface between the heat shielding enclosure and a turbocharger is particularly difficult due to the structure of the turbocharger. The compressor section of a turbocharger has a compressor cover, which is also known as a compressor housing. The compressor is connected by a center housing to the turbocharger turbine. The center housing contains the turbocharger cartridge containing bearings and the shaft connecting the compressor wheel and turbine wheel. The bearings and shaft require lubrication, such as oil, and coolant, such as water. Thus, coolant and oil lines are connected with the center housing, adding additional complexity to the turbocharger structure. Oil sumps may also be connected with turbochargers, adding another detail. The turbocharger turbine has its own housing, which is connected with the outlet elbow. The air that enters a turbocharger compressor during normal operation generally will have a temperature less than 50° C. (122° F.). However, the exhaust gas entering the turbocharger turbine contains significant heat. In some engines, exhaust gas entering the turbocharger turbine may reach and exceed 800° C. Exhaust gas entering the exhaust outlet elbow may reach and exceed 426.7° C. (800° F.). This can cause the turbocharger turbine, turbocharger turbine housing, and exhaust outlet elbow to reach high temperatures. Thus, a heat shielding enclosure may enclose the turbocharger turbine housing, but may leave out the turbocharger compressor housing.

Some prior art methods and apparatuses using gaskets for improved seals of engine components include spiral wound gaskets disposed between the exhaust manifold and the exhaust duct. For example, U.S. Pat. No. 6,055,806, filed on May 8, 1998, and assigned to Caterpillar Inc., discloses an apparatus for providing a leak proof seal and thermal liner through the use of a spiral wound, chevron-shaped gasket disposed between the flat bottom of a counter bore of an exhaust duct and the end portions of an exhaust manifold. However, these methods and apparatuses have been somewhat disadvantageous for multiple reasons, including, but not limited to the steel construction of the gasket and the attachment by welding.

### SUMMARY

In one aspect, the disclosure describes aspects of a turbocharger gasket apparatus adapted to be compressed onto a heat shielding enclosure responsive to pressure from a turbocharger housing. In one aspect, the gasket comprises a compressible material, which, in an aspect, may be a ceramic material surrounding insulating material. The turbocharger housing may be a turbocharger central housing. The turbocharger gasket may be removable and may further comprise a clip. In one embodiment, the turbocharger gasket does not degrade in response to changes in temperature.

In one aspect, the disclosure describes aspects of a heat shielding enclosure system with a removable, compressible gasket. The gasket may be an exhaust manifold conduit gasket disposed in an exhaust manifold conduit port of the heat shielding enclosure. The gasket may also be an outlet exhaust elbow gasket disposed in an outlet exhaust elbow port of the heat shielding enclosure. The gasket may also be an exhaust manifold thermocouple gasket disposed about an exhaust manifold thermocouple port of the heat shielding enclosure. The gasket may also be an outlet exhaust thermocouple gasket disposed about a thermocouple port of an outlet exhaust elbow of the heat shielding enclosure. In one embodiment, the gasket is comprised of a ceramic material surrounding insulating material.

More specifically, in one aspect, the disclosure provides for the heat shielding enclosure to have serviceable gaskets comprised of a malleable ceramic fiber weave surrounding a heat shielding filler. In accordance with this aspect, the serviceable gaskets are shaped to conform to interfaces with a turbocharger, an exhaust manifold, an exhaust outlet elbow, and a thermocouple. The heat shielding enclosure is configured to enclose a portion of the turbocharger. A serviceable gasket is disposed between the turbocharger chassis and the permanent insulation of the heat shielding enclosure, a groove inlaid in the permanent insulation to capture the serviceable gasket. A serviceable gasket is disposed between the outlet elbow and the permanent insulation of the heat shielding enclosure. A serviceable gasket is disposed between a conduit from the exhaust manifold and the heat shielding enclosure. A serviceable gasket is disposed about the thermocouple wire housing. During normal operation, the serviceable gaskets form a seal from the pressure of the mating component. The seal operates to close gaps between the mating component and the permanent insulation of the heat shielding enclosure. Heat and gas inside the heat shielding enclosure are contained by the seals.

In another aspect, the disclosure provides for an engine and a heat shielding enclosure adapted to interface with the engine, the heat shielding enclosure having a removable, compressible gasket. In one embodiment, the engine has a turbocharger. The heat shielding enclosure interfaces with the turbocharger, and the removable, compressible gasket is a turbocharger gasket disposed about the interface of the heat shielding enclosure and the turbocharger. In another embodiment, the engine further has an exhaust manifold conduit, and the heat shielding enclosure interfaces with the exhaust manifold conduit. In this embodiment, the removable, compressible gasket is an exhaust manifold conduit gasket disposed about the interface of the heat shielding enclosure and the exhaust manifold conduit. In another embodiment, the engine has an outlet exhaust elbow, and the heat shielding enclosure interfaces with the outlet exhaust elbow. In this embodiment, the removable, compressible gasket is an outlet exhaust elbow gasket disposed about the interface of the heat shielding enclosure and the outlet exhaust elbow. In another embodiment, the engine has an exhaust manifold thermocouple and the heat shielding enclosure interfaces with the exhaust manifold thermocouple. In this embodiment, the removable, compressible gasket is an exhaust manifold thermocouple gasket. In another embodiment, the engine further has a turbocharger outlet thermocouple and the heat shielding enclosure interfaces with the turbocharger outlet thermocouple. In this embodiment, the removable, compressible gasket is a turbocharger outlet thermocouple

### BRIEF DESCRIPTION OF THE DRAWINGS

FIG. 1 is an exemplary illustration of an engine with a heat shielding enclosure having gaskets in accordance with one aspect of the present disclosure;

FIG. 2 is an exemplary illustration of a heat shielding enclosure in accordance with one aspect of the present disclosure;

FIG. 3 is an exemplary illustration of a section view of a heat shielding enclosure in accordance with one aspect of the present disclosure;

FIG. 4 is an exemplary illustration of an isometric view of an outlet exhaust elbow gasket in accordance with one aspect of the present disclosure;

FIG. 5 is an exemplary illustration of a top view of a heat shielding enclosure with an outlet exhaust elbow gasket in accordance with one aspect of the present disclosure;

FIG. 6 is an exemplary illustration of a section view of a heat shielding enclosure with an outlet exhaust elbow gasket in accordance with one aspect of the present disclosure;

FIG. 7 is an exemplary illustration of an isometric view of an exhaust manifold gasket in accordance with one aspect of the present disclosure;

FIG. 8 is an exemplary illustration of a section view of an exhaust manifold gasket disposed in an exhaust manifold in accordance with one aspect of the present disclosure;

FIG. 9 is an exemplary illustration of an isometric view of an exhaust manifold thermocouple gasket in accordance with one aspect of the present disclosure;

FIG. 10 is an exemplary illustration of a section view of an exhaust manifold thermocouple gasket disposed in a heat shielding enclosure in accordance with one aspect of the present disclosure;

FIG. 11 is an exemplary illustration of a turbocharger outlet thermocouple gasket in accordance with one aspect of the present disclosure;

FIG. 12 is an exemplary illustration of a turbocharger outlet thermocouple gasket mounted in a heat shielding enclosure in accordance with one aspect of the present disclosure;

FIG. 13 is an exemplary illustration of a isometric view of a turbocharger gasket in accordance with one aspect of the present disclosure;

FIG. 14 is an exemplary illustration of a section view of a turbocharger gasket disposed in a heat shielding enclosure in accordance with one aspect of the present disclosure;

### DETAILED DESCRIPTION

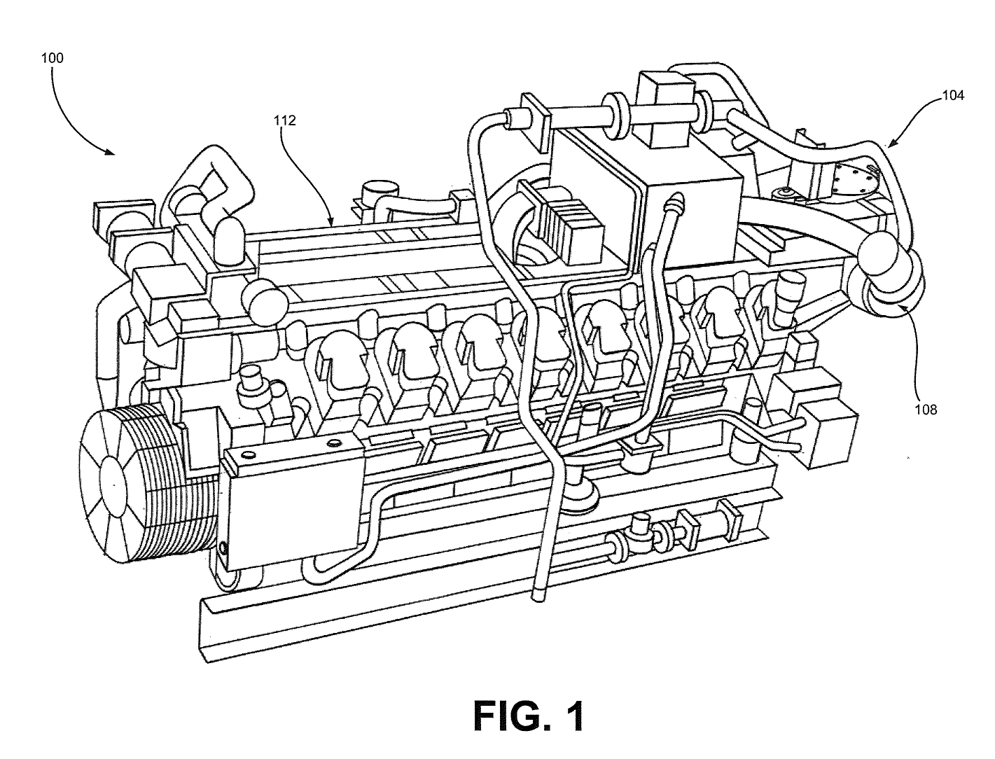

Now referring to the drawings, wherein like reference numbers refer to like elements, FIG. 1 is an exemplary illustration of engine 100 with heat shielding enclosure 104. Engine 100 may include an ignition system, valves, pistons and corresponding cylinders, a crankshaft, a flywheel, and a fuel system. Engine 100 may further include an air inlet system, an intercooler, and an aftercooler, and may also include a water jacket, pump, reservoir, radiator, and piping.

During normal engine operation, the combustion process creates exhaust gases. The exhaust passes from the cylinders of engine 100 into exhaust manifold 112. Exhaust manifold 112 may have several pipes or conduits for directing the flow of exhaust gas. Each cylinder may have a pipe, and the individual cylinder pipes may be organized into one or more banks. The banks may connect the individual cylinder exhaust pipes into a common pipe. The pipes of exhaust manifold 112 pass into heat shielding enclosure 104. Turbocharger 108 is connected with heat shielding enclosure 104. As shown, turbocharger 108 and heat shielding enclosure 104 are located at the flywheel end of engine 100.

While engine 100 is shown, it should be appreciated that heat shielding enclosure 104 may be used in conjunction with many different engines. For example, heat shielding enclosures may be used with marine engines (propulsion engines, marine generator sets, auxiliary engines, etc.), gas compression engines, and in electric power generation engines.

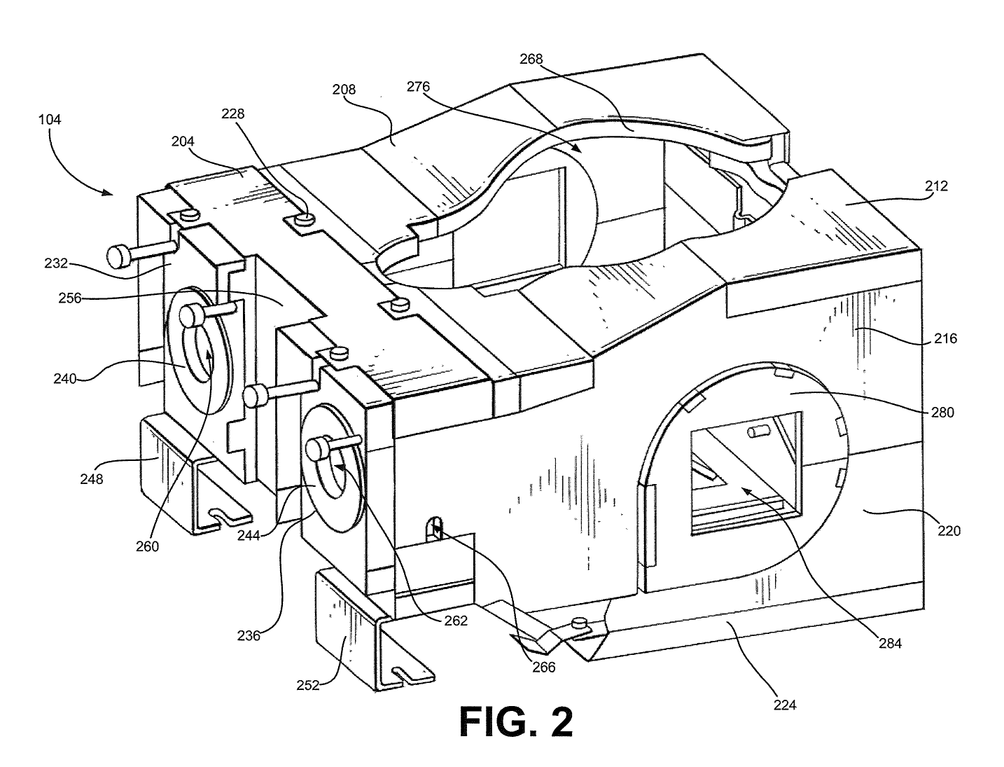

An exemplary illustration of heat shielding enclosure 104 in accordance with some aspects of the present disclosure is shown in FIG. 2. Heat shielding enclosure 104 is a heat sink which absorbs heat from engine components it is in contact with and that it encloses. Furthermore, it acts as a physical barrier between the hot engine components and the engine operating environment, including any operators. Heat shielding enclosure 104 has several heat shields 204, 208, 212, 216, 220, 224, 232, 236, 256, which may be sheet metal and may be thermo-laminated. These heat shields may be connected by bolts, such as bolt 228, or by other methods, to form heat shielding enclosure 104. A first lateral face of heat shielding enclosure 104 faces the exhaust manifold of the engine. Mounting brackets 248, 252 assist in connecting heat shielding enclosure 104 with the engine. The pipes of the exhaust manifold of the engine (not shown) pass through the substantially circular port 260 and port 262. Exhaust manifold conduit gasket 240 and exhaust manifold conduit gasket 244 are set in heat shield 232 and heat shield 236, respectively. Exhaust manifold conduit gaskets 240, 244 provide a seal between the exhaust manifold pipes and heat shielding enclosure 104. Turbocharger ports in heat shielding enclosure 104, such as turbocharger port 284, allow for turbochargers to be inserted. Exhaust outlet elbow port 276 is defined by heat shields, such as heat shield 208, heat shield 204, and heat shield 212. Exhaust outlet elbow gasket 268 sits between the heat shielding and exhaust outlet elbow port 276.

While two ports are shown, the heat shielding enclosure 104 may be constructed to accept any number of exhaust manifold conduit configurations. Furthermore, while heat shielding enclosure 104 is shown as accepting two turbochargers, heat shielding enclosure 104 may accept a single turbocharger, more than two turbochargers, or no turbochargers. Heat shielding enclosure 104 may be constructed to accept and enclose different engine components based on the engine or the particular components desired to be shielded. Thus, heat shielding enclosure 104 may have different shapes as required by the components it is enclosing. Heat shielding enclosure 104 is not limited to any particular shape.

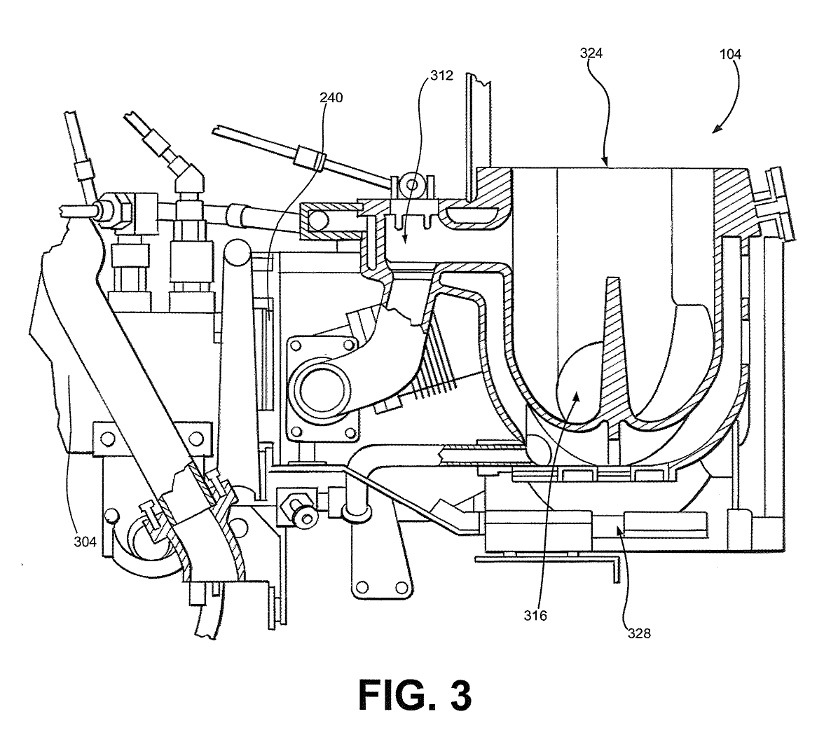

As best shown in FIG. 3, a section view of heat shielding enclosure 104 in accordance with some aspects of the present disclosure is shown. Exhaust manifold conduit gasket 240 seals the interface where exhaust manifold conduit 304 connects with heat shielding enclosure 104. Outlet exhaust elbow 324 has turbocharger exhaust port 316 and wastegate 312. Turbocharger outlet thermocouple gasket 328 is disposed beneath outlet exhaust elbow 324.

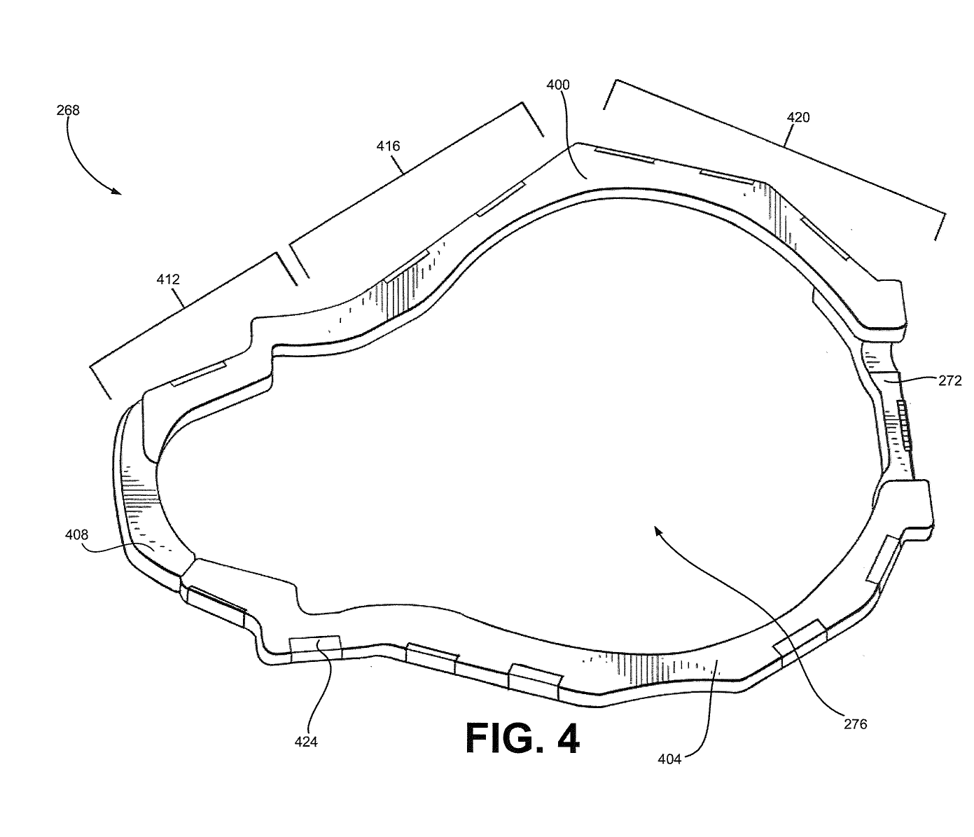

As best shown in FIG. 4, an isometric view of outlet exhaust elbow gasket 268 in accordance with some aspects of the present disclosure is shown. Outlet exhaust elbow gasket 268 has arm 400 and arm 404 connected at a first end by foot 408 and at a second end by crown 272. Arm 400 is comprised of a stepped first end 412 connected with an angled middle portion 416. Middle portion 416 is connected with arcuate second end 420. Arm 404 is formed similarly to arm 400 but with an orientation opposite that of arm 400. Clips 424 may be added to exhaust outlet elbow gasket 268 segments. The connections between components of exhaust outlet elbow gasket 268 may be interference fit connections.

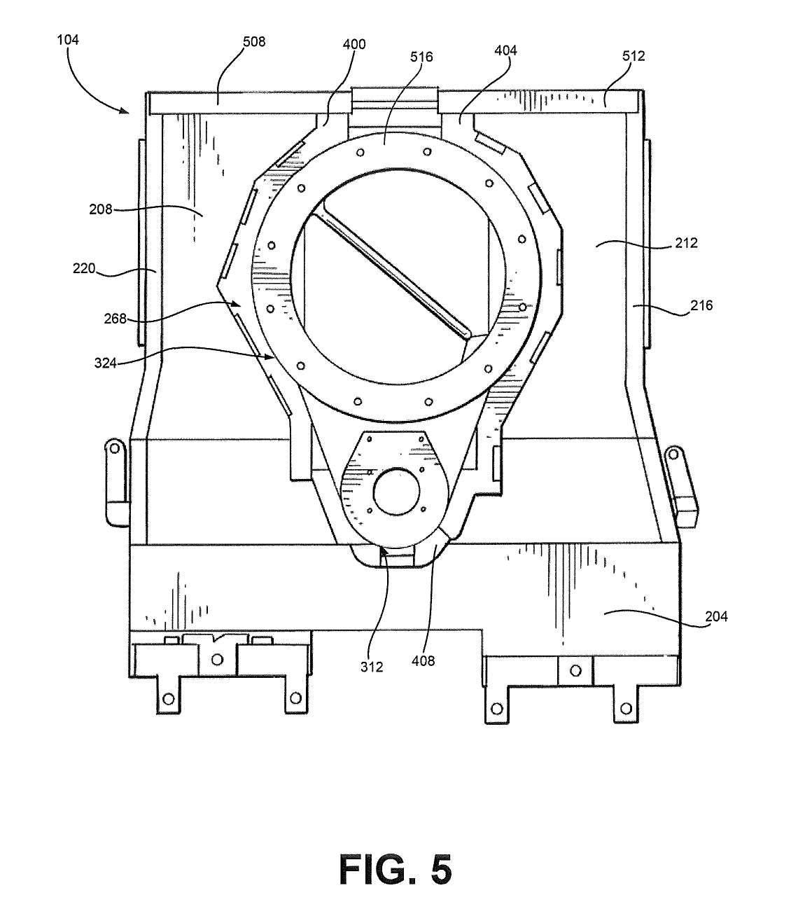

As best shown in FIG. 5, a top view of a heat shielding enclosure 104 with outlet exhaust elbow gasket 268 is shown according to some aspects of the present disclosure. The rigidness of heat shielding enclosure 104 and exhaust outlet elbow 324 causes the relatively soft, pliable gasket 268 to be compressed, creating an interference fit of gasket 268 between heat shielding enclosure 104 and exhaust outlet elbow 324. The compression causes exhaust outlet elbow gasket 268 to responsively change shape, filling the interstices between heat shielding enclosure 104 and exhaust outlet elbow 324. This creates a tight, effective seal between heat shielding enclosure 104 and exhaust outlet elbow 324. Exhaust outlet elbow flange 516, which may be connected with an exhaust stack (not shown), has clearance above the interface between the outer casing of exhaust outlet elbow 324 and exhaust outlet elbow gasket 268. In one embodiment, grooves (not shown) may be set in heat shields 208, 212, 204, 508, 512 to accept exhaust outlet elbow gasket 268.

Outlet exhaust elbow gasket 268 is sized and elastomeric to the extent that pressure exerted by heat shields of heat shielding enclosure 104 and exhaust outlet elbow 324 on gasket 268 cause a tight seal to be formed. Direct lateral pressure from heat shield 208 and the outer casing of exhaust outlet elbow 324 holds arm 400 in place and prevents heat from escaping. Direct lateral pressure from heat shield 508 and heat shield 204 perpendicular to that of the lateral pressure also keep arm 268 in position and tightens the seal. Similarly, gasket arm 404 is held by the lateral pressure of the outer casing of exhaust outlet elbow 324 and heat shields 212 and 216. Perpendicular pressure from heat shields 512 and 204 perpendicular to that of the lateral pressure also keep arm 404 in position and tighten the seal. Direct pressure from the casing of wastegate 312 of outlet exhaust elbow 324 and heat shield 204 compresses gasket foot 408, forming a tight seal. Gasket crown 272 (not shown—shown in FIG. 4) is similarly compressed by heat shields 508 and 512 and the casing of exhaust outlet elbow 324.

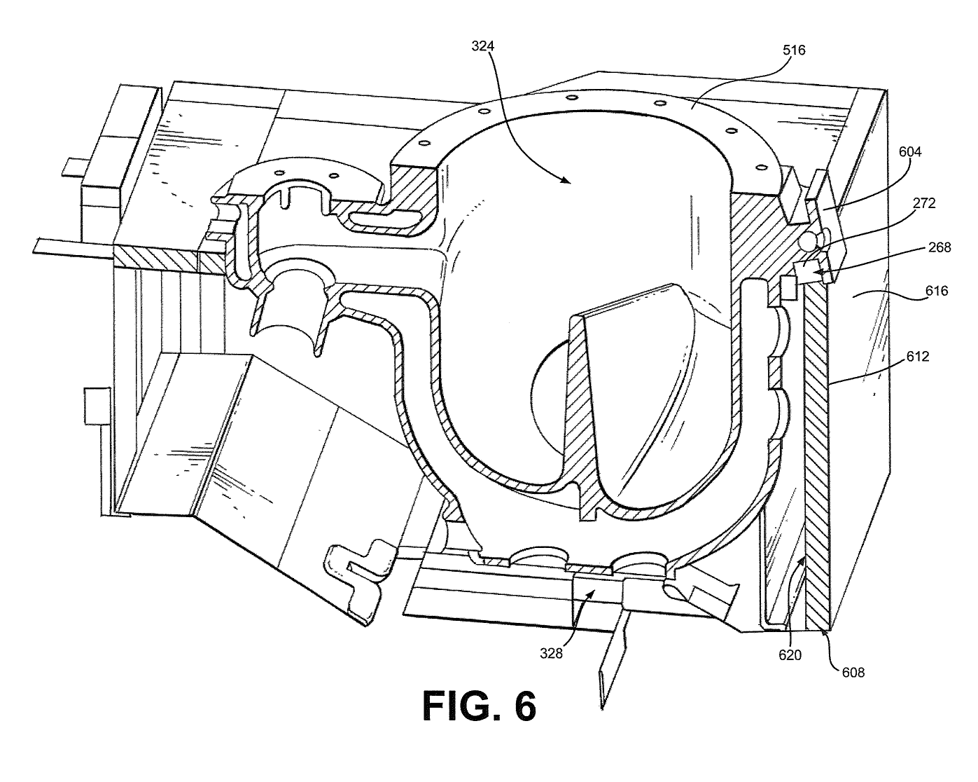

As best seen in FIG. 6, a section view of an outlet exhaust elbow 324 with gasket 268 is shown according to some aspects of the present disclosure. Outlet elbow exhaust elbow crown gasket 272 of outlet elbow exhaust gasket 268 is disposed below bracket assembly 604 of outlet exhaust elbow 324. Gasket 272 is compressed between the casing of outlet exhaust elbow 324 and the rear heat shielding 608 of heat shielding enclosure 104. The insulation 612 of rear heat shielding 608 is shown between skin 616 and 620.

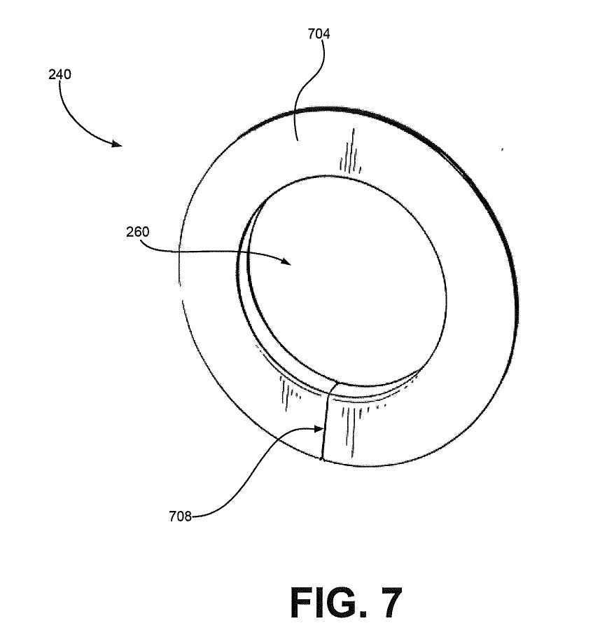

As best seen in FIG. 7, an isometric view of exhaust manifold conduit gasket 240 is shown according to some aspects of the disclosure. Exhaust manifold conduit gasket 240 has an annular ring shape, forming port 260. Exhaust manifold conduit gasket 240 may be formed from an elongate section of gasket material and shaped into gasket ring 704, with two mating faces forming seam 708. The length of the gasket material, and the corresponding diameter of port 260, may vary depending on the size of the exhaust manifold gasket pipe and the size of the opening in the corresponding heat shielding enclosure. In one embodiment, the gasket material is an insulating material encased in a ceramic weave.

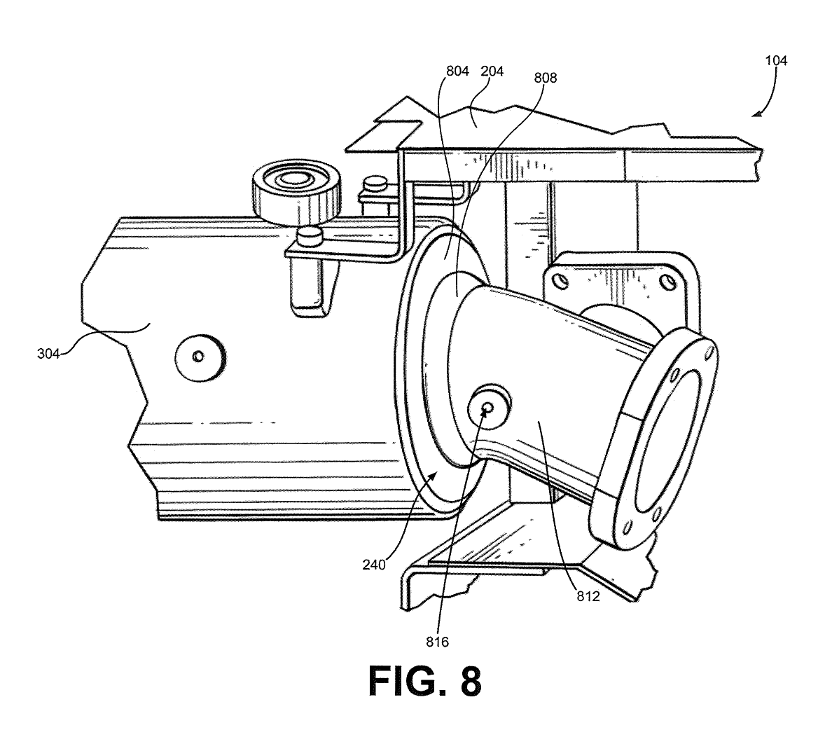

As best seen in FIG. 8, a section view of exhaust manifold conduit gasket 240 disposed about an exhaust manifold is shown according to some aspects of the disclosure. Exhaust manifold conduit gasket 240 may be disposed around exhaust manifold conduit 304 forming a radial seal between exhaust manifold conduit and its mating interface with heat shielding enclosure 104. Exhaust manifold conduit gasket 240 has a first diameter 804 and a second diameter 808, creating a step-down. This step-down accommodates a portion of the exhaust manifold 812 that extends into the heat shielding enclosure 104. Exhaust manifold extension 812 may have thermocouple port 816 to accept a thermocouple for measuring the temperature of exhaust air entering the heat shielding enclosure 104. Thermocouple port 816 may be substantially cylindrical.

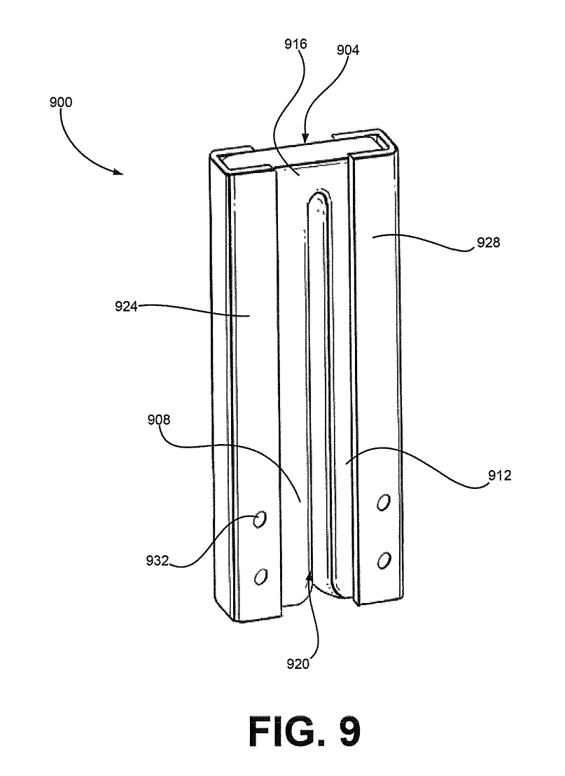

As best seen in FIG. 9, an isometric view of exhaust manifold thermocouple gasket 900 is shown in accordance with one aspect of the present disclosure. Exhaust manifold gasket 900 has gasket body 904 of two elongate gasket legs 908, 912 connected by gasket bridge 916. Elongate gasket legs 908 and 912 may have curved ends. Elongate gasket legs 908 and 912 are in substantial contact along their length, the faces of elongate gasket legs 908 and 912 pressing together to form thermocouple seam 920. A thermocouple wire (not shown), or other kind of wire, may pass through thermocouple seam 920. Thermocouple seam 920 allows the wire to be passed through and forms a seal around the wire, preventing heat from passing through. Exhaust manifold thermocouple gasket 900 may have sleeves 924, 928. Sleeves 924, 928 may have a C channel shape. The outer edges of legs 908 and 912 may be situated in these channels, the pressure from sleeves 924 and 928 keeping gasket body 904 in position. Sleeves 924 and 928 remain rigid while gasket body 904 may be “soft.” Sleeves 924 and 928 may have connection points, such as opening 932. The soft characteristic of gasket body 904 allows the thermocouple wire to be passed through while pressure is maintained between elongate gasket legs 908, 912. A radial seal is formed by gasket body 904 around the thermocouple wire as it passes through exhaust manifold thermocouple gasket 900.

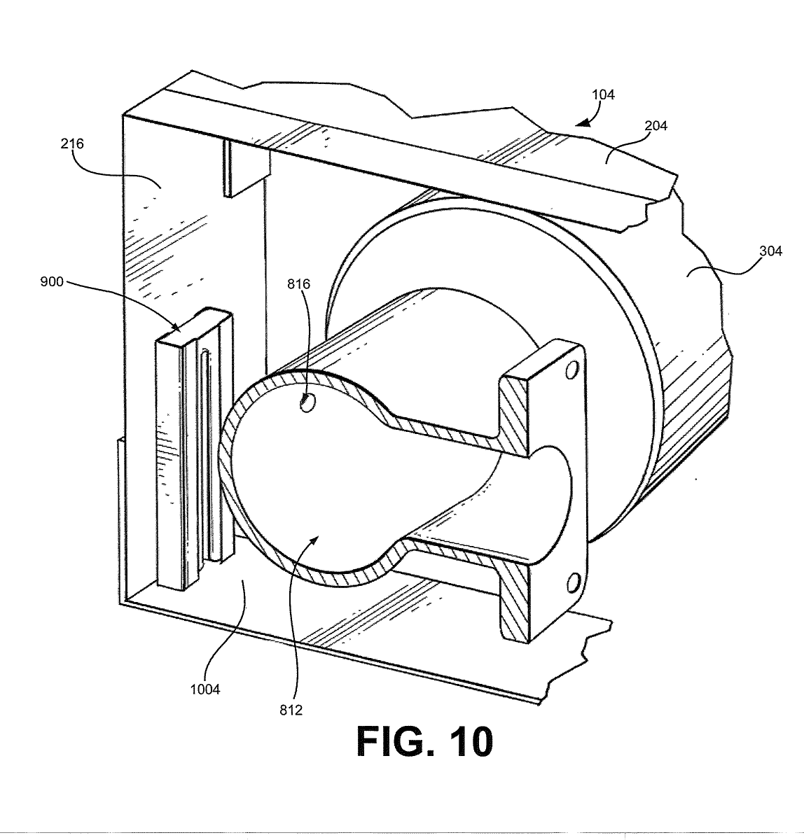

As best seen in FIG. 10, a section view of exhaust manifold thermocouple gasket 900 disposed in heat shielding enclosure 104 is shown in accordance with one aspect of the present disclosure. A thermocouple may be used to measure the temperature of exhaust gas in the exhaust manifold. When a turbocharger is attached, an exhaust manifold thermocouple allows for the exhaust gas temperature to be monitored as it flows into the turbocharger turbine. Heat may be prevented from escaping the enclosure and from melting or otherwise damaging the thermocouple wire by exhaust manifold thermocouple gasket 900. The thermocouple enters heat shielding enclosure at exhaust manifold thermocouple interface 266 (shown in FIG. 2). Exhaust manifold thermocouple gasket 900 is disposed inside of heat shielding enclosure 104 opposite exhaust manifold thermocouple interface 266, abutting exterior-facing insulating material and heat shield 216, above heat shield 1004, and below heat shield 204. While a single thermocouple and exhaust manifold extension 812 is shown, multiple thermocouples may be used with a single exhaust manifold extension or with multiple extensions, which may carry exhaust to other components, such as wastegate 312 (as shown in FIG. 3 and FIG. 5).

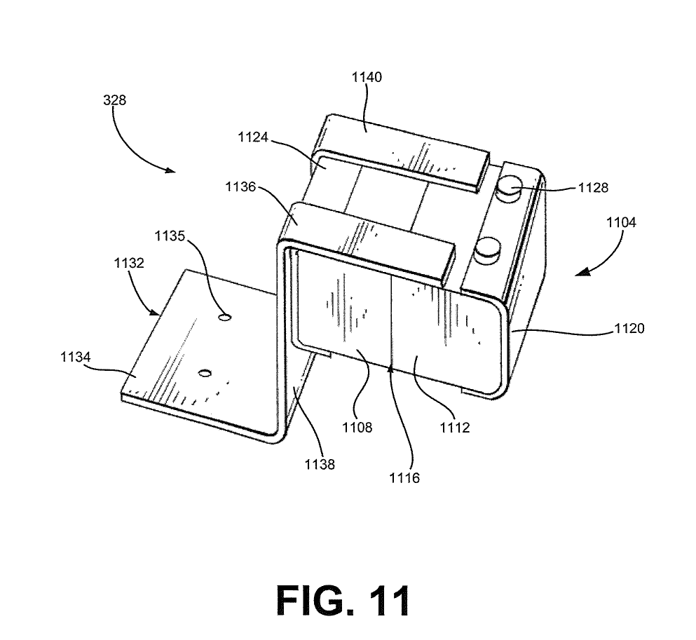

As best seen in FIG. 11, an isometric view of turbocharger outlet thermocouple gasket 328 is shown in accordance with one aspect of the present disclosure. Turbocharger outlet thermocouple gasket 328 may have gasket bodies 1108, 1112 compressed together forming seam 1116. A thermocouple may be passed between the mating faces of compressed gasket bodies at seam 1116. Housings 1120, 1124 may be placed laterally adjacent to gasket bodies 1108, 1112 on the outer edges opposite the edges forming seam 1116. Housings 1120 may be secured to gasket bodies 1108, 1112 by bolts, screws, and the like, such as bolt 1128. Additionally, turbocharger outlet thermocouple gasket 328 may be connected with bracket 1132 to mount the gasket in the appropriate position inside heat shielding enclosure 104. Bracket 1132 has base 1134, which may have attachment points 1135. Base 1134 may be connected with stand 1138 at stand's 1138 first end. Stand 1138 is perpendicular to base 1134, prongs 1136, 1140 extend from the second end of stand 1138.

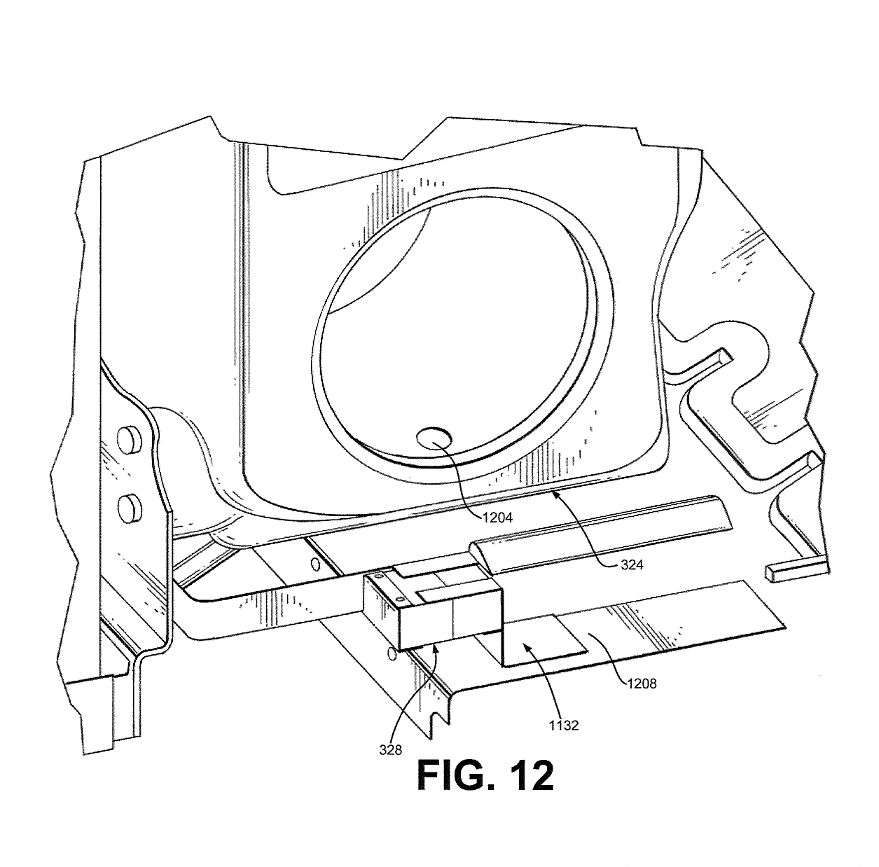

As best seen in FIG. 12, turbocharger outlet thermocouple gasket 328 in heat shielding enclosure 104 is shown in accordance with one aspect of the present disclosure. Turbocharger outlet thermocouple gasket 328 is disposed below outlet exhaust elbow 324. A thermocouple may extend into outlet exhaust elbow gasket 324 via thermocouple port 1204 to measure the temperature of air exiting a turbocharger. Multiple turbocharger outlet thermocouple gaskets 328 may be used in conjunction with multiple thermocouples. Multiple thermocouples may be used to measure the temperature of air exiting one or more turbochargers 108. Furthermore, while FIG. 12 shows turbocharger outlet thermocouple gasket 328 disposed below outlet exhaust elbow gasket 324, thermocouple gasket 328 may be placed in different locations, with thermocouple port 1204 aligned.

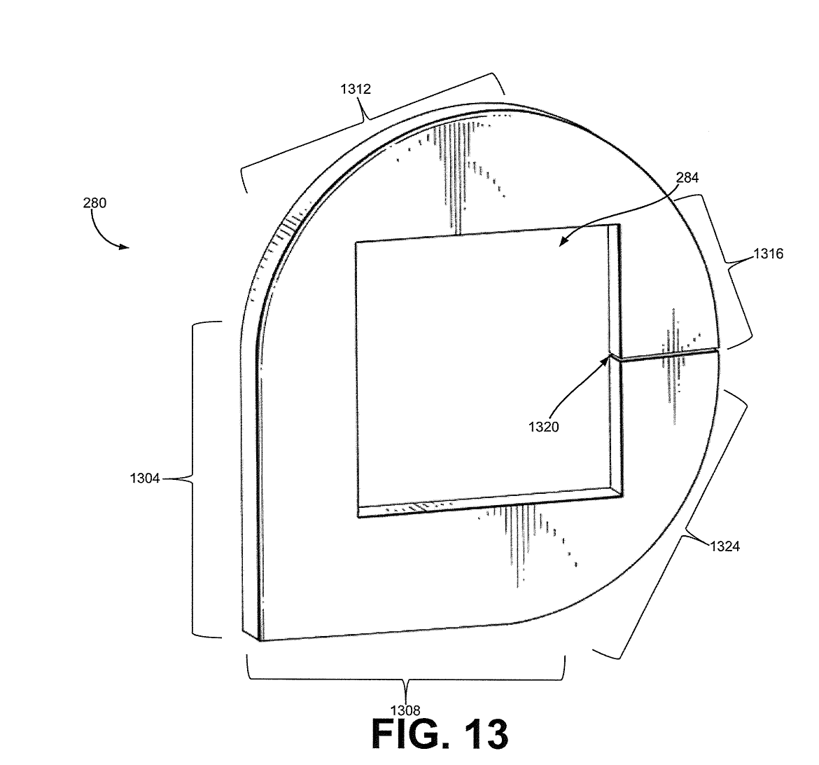

As best seen in FIG. 13, an isometric view of turbocharger gasket 280 is shown in accordance with one aspect of the present disclosure. Turbocharger gasket 280 defines an approximately rectangular turbocharger central housing opening 284. While the approximately rectangular form of turbocharger central housing opening 284 may have dimensions approximately or exactly uniform length, the outer edge of turbocharger gasket 280 is not uniform. First rectangular section 1304 and second rectangular section 1308 meet to define an approximate right angle. Rectangular section 1304 extends into arcuate section 1312. Rectangular section 1308 extends into arcuate section 1324. Arcuate section 1312 extends into terminating section 1316. Arcuate section 1324 and terminating section 1316 have mating faces which form seam 1320.

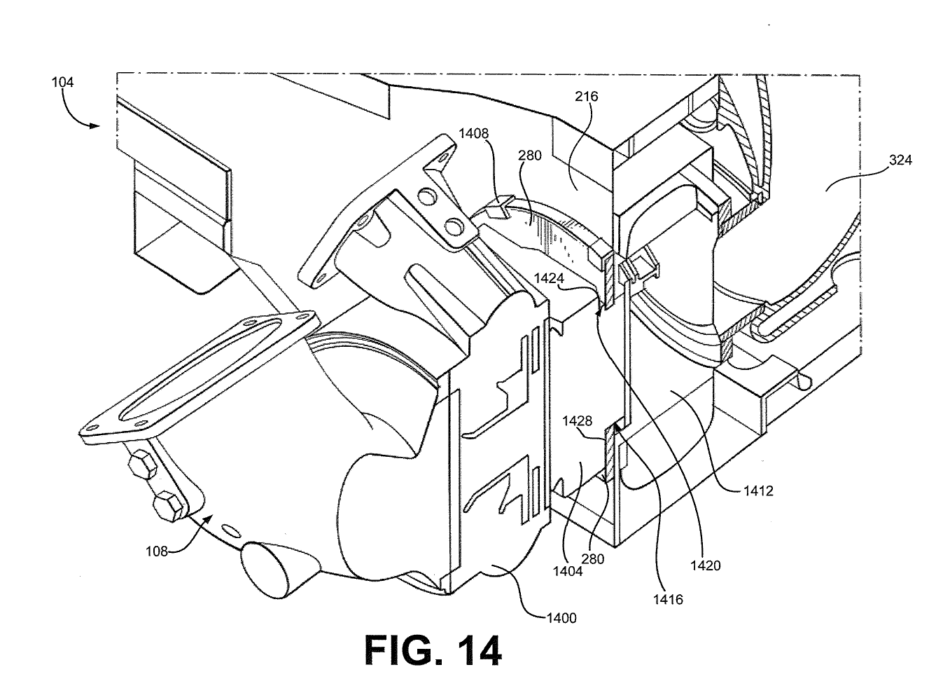

As best seen in FIG. 14, a section view of turbocharger gasket 280 in heat shielding enclosure 104 is shown in accordance with one aspect of the present disclosure. Central housing 1404 of turbocharger 108 mates with and passes through port 284 (as shown in FIG. 2), connecting with turbocharger turbine housing 1412. Turbocharger turbine housing 1412 is displaced inside heat shielding enclosure 104 and is in flow connection with exhaust outlet elbow 324. As central housing 1404 passes through port 284, it compresses turbocharger gasket 280 against heat shielding enclosure 104. Central housing 1404 has step down 1416, 1420 where the width of central housing 1404 decreases. First step-down face 1424 and second step-down face 1428 provide the direct pressure against turbocharger gasket 280 against the exterior of heat shielding enclosure 104, such as against heat shield 216. The compression of turbocharger gasket 280 causes it to seal port 284 as it expands between turbocharger central housing 1404 and heat shielding enclosure 104. Turbocharger 108 interfaces with heat shielding enclosure 104. Clips 1408 may be present along the outer edge of turbocharger gasket 280. Clips 1408 may help prevent gasket 280 from moving out of position.

Gaskets 268, 240, 244, 280, 328, 900 may be comprised of a high temperature-rated ceramic material surrounding insulating material. The ceramic material may be a weave encasing the insulating material. The gaskets may be constructed by sewing or stitching ceramic fabric pieces around a filler material. The relative softness of this material allows the gaskets to alter shape in response to pressure from rigid components, filling interstices and creating tight seals. Heat is not required to make the gaskets seal and the compliancy of the gaskets will not change at high temperature and will not degrade due to changes in temperature. Seals will be maintained from the first installation at room temperature up through operating temperature.

A visual inspection allows an operator to determine if a gasket is effectively sealing, and a defective or worn gasket may be serviced. Service may also be performed for required maintenance, in response to damage, or to comply with regulations, for example. Servicing gaskets 268, 240, 244, 280, 328, 900 may include, for example, repairing, resituating, or replacing a gasket. Gaskets 268, 240, 244, 280, 328, 900 may be serviced without removing or modifying any structures or components of the box, such as heat shields. However, permanent insulation or metal skins may be removed from heat shielding enclosure 104 in order to service gaskets 268, 240, 244, 280, 328, 900. For example, to service turbocharger gasket 280, heat shields 216 and 220 may be removed. Heat shields 204, 208, and 212 may be removed to service outlet exhaust elbow gasket 268. Heat shield 232 may be removed to service exhaust manifold conduit gasket 240. Heat shield 236 may be removed to service exhaust manifold conduit gasket 244. Heat shield 216 may be removed to service exhaust manifold thermocouple gasket 900. Heat shield 224 may be removed to service turbocharger outlet thermocouple gasket 328. However, it should be appreciated that these heat shields are for a particularly disclosed embodiment. Heat shielding enclosures may have different configurations and other arrangements of heat shields, skins, and insulation, that require different components to be removed in order to replace gaskets.

When a component is serviced, a gasket may be serviced as well. For example, when a component, such as turbocharger 108, is serviced, enclosure 104 may be removed along with turbocharger gasket 280. Turbocharger gasket 280 may be replaced with a new gasket, or may be resituated when service is finished. Thus, service may be performed on a gasket opportunistically when service is being performed on engine components heat shielding enclosure 104 interfaces with, or because of a desire to service gasket 268, 240, 244, 280, 328, 900.

### INDUSTRIAL APPLICABILITY

The present disclosure is applicable to heat shielding enclosures. Gaskets for heat shielding enclosures are an important part engine heat regulation systems. The use of gaskets may improve seals for openings in a heat shielding enclosure, such as the openings for exhaust manifolds, turbochargers, exhaust outlet elbows, and thermocouples. Seal improvements allow for improved control over engine radiant heat. Regulation of heat requires keeping temperatures significantly below the flashpoint of gases such as natural gas, butane, and methane, as well as oil. Additionally, by controlling engine radiant more effectively, secondary cooling systems, such as engine room ventilation systems, may be put under less pressure. Other systems, such as generators and switchgear, may be better protected by a better controlled ambient temperature in engine room environments.

Serviceable seals are also more economical. Serviceable seals allow for quicker, less expensive servicing of heat shielding enclosures. This desirable feature allows gaskets to be replaced without replacing an entire heat shielding enclosure or heat shielding skins and permanent insulation. Additionally, serviceable seals are advantageous over permanent seals because permanent seals do not provide as effective of a seal.

The many features and advantages of the disclosure are apparent from the detailed specification, and, thus, it is intended by the appended claims to cover all such features and advantages of the disclosure which fall within its true spirit and scope. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

We claim:

1. An apparatus comprising:
a turbocharger gasket adapted to be compressed onto a heat shielding enclosure responsive to pressure from a turbocharger housing.

2. The apparatus of claim 1, wherein the turbocharger gasket comprises a compressible material.

3. The apparatus of claim 2, wherein the material is a ceramic material surrounding insulating material.

4. The apparatus of claim 1, wherein the turbocharger housing is a turbocharger central housing.

5. The apparatus of claim 1, wherein the turbocharger gasket further comprises a clip.

6. The apparatus of claim 1, wherein the turbocharger gasket is removable.

7. The apparatus of claim 1, wherein the turbocharger gasket does not degrade in response to changes in temperature.

8. A system comprising:
a heat shielding enclosure with a removable, compressible gasket.

9. The system of claim 8, wherein the gasket is an exhaust manifold conduit gasket disposed in an exhaust manifold conduit port of the heat shielding enclosure.

10. The system of claim 8, further comprising an outlet exhaust elbow gasket disposed in an outlet exhaust elbow port of the heat shielding enclosure.

11. The system of claim 8, wherein the gasket is an exhaust manifold thermocouple gasket disposed about an exhaust manifold thermocouple port of the heat shielding enclosure.

12. The system of claim 8, wherein the gasket is an outlet exhaust thermocouple gasket disposed about a thermocouple port of an outlet exhaust elbow of the heat shielding enclosure.

13. The system of claim 8, wherein the gasket is a turbocharger gasket disposed about a turbocharger port of the heat shielding enclosure.

14. The system of claim 8, wherein the gasket is comprised of a ceramic material surrounding insulating material.

15. A system comprising:
an engine; and
a heat shielding enclosure adapted to interface with the engine, wherein the heat shielding enclosure has a removable, compressible gasket.

16. The system of claim 15, wherein the engine further comprises a turbocharger, the heat shielding enclosure interfacing with the turbocharger, and the removable, compressible gasket comprising a turbocharger gasket disposed about the interface of the heat shielding enclosure and the turbocharger.

17. The system of claim 15, wherein the engine further comprises an exhaust manifold conduit, the heat shielding enclosure interfacing with the exhaust manifold conduit, and the removable, compressible gasket comprising an exhaust manifold conduit gasket disposed about the interface of the heat shielding enclosure and the exhaust manifold conduit.

18. The system of claim 15, wherein the engine further comprises an outlet exhaust elbow, the heat shielding enclosure interfacing with the outlet exhaust elbow, and the removable, compressible gasket comprising an outlet exhaust elbow gasket disposed about the interface of the heat shielding enclosure and the outlet exhaust elbow.

19. The system of claim 15, wherein the engine further comprises an exhaust manifold thermocouple, the heat shielding enclosure interfacing with the exhaust manifold thermocouple, and the removable, compressible gasket comprising an exhaust manifold thermocouple gasket.

20. The system of claim 15, wherein the engine further comprises a turbocharger outlet thermocouple, the heat shielding enclosure interfacing with the turbocharger outlet thermocouple, and the removable, compressible gasket comprising a turbocharger outlet thermocouple gasket.
